(19) United States
(12) Patent Application Publication
(10) Pub. No.: US 2014/0238943 A1
(43) Pub. Date: Aug. 28, 2014

(54) Method For Treating Suspensions Of Solid Particles In Water Using Post Hydrolyzed Polymers

(71) Applicants: Cedrick Favero, Saint Romain Le Puy (FR); Scott Ramey, Brunswick, GA (US); Trong Dang-Vu, Edmonton (CA)

(72) Inventors: Cedrick Favero, Saint Romain Le Puy (FR); Scott Ramey, Brunswick, GA (US); Trong Dang-Vu, Edmonton (CA)

(21) Appl. No.: 13/774,391

(22) Filed: Feb. 22, 2013

(51) Int. Cl. C02F 1/52

(52) U.S. Cl. CPC C02F 1/5272
USPC 210/734; 210/732; 210/733

(57) ABSTRACT

A method for treating a suspension of mineral particles in water, such as mineral tailings, includes the step of contacting the suspension of mineral particles in water with a specific water-soluble polymer. This polymer is preferably a water-soluble polymer having an anionicity of between 10 to 55 mol %, and more preferably 20 to 50 mol %. Furthermore, this polymer has preferably a molecular weight between 15 and 40 million daltons, and more preferably between 18 and 30 million. The method involves adding the specific polymer into a thickener containing the tailings to treat, and/or during transport of the suspension to a deposition area for dewatering and solidification, or to the tailings to treat followed by a mechanical treatment such as centrifugation, screw press and filtration.

### FIELD OF THE INVENTION

The invention relates to a method for treating a suspension of mineral particles in water, such as mineral tailings. This method includes the step of contacting the suspension of mineral particles in water with a specific water-soluble polymer. This polymer is preferably a water-soluble polymer having an anionicity of between 10 to 55 mol %, and more preferably 20 to 50 mol %. Furthermore, this polymer has preferably a molecular weight comprised between 15 and 40 millions daltons, and more preferably between 18 and 30 millions. The method consists of adding said specific polymer into a thickener containing the tailings to treat, and/or during transport of said suspension to a deposition area for dewatering and solidification, or to the tailings to treat followed by a mechanical treatment such as centrifugation, screw press and filtration.

### BACKGROUND OF THE INVENTION

The invention relates to a method for treating suspensions of solid particles in water. More precisely, the invention relates to a method for treating suspension of mineral particles in water with a water-soluble polymer which is first produced with a low anionicity level (preferably less than 10 mol %) and is further modified to have a total anionicity level preferably ranging from 10 to 55 mol %.

Suspensions of mineral particles in water include all types of sludge, tailings, or waste materials. The suspensions result from mineral ores processes. They are for instance industrial sludge or tailings and all mine wash and waste products resulting from exploiting mines, such as, for example, coal mines, diamonds mines, phosphate mines, metal mines (alumina, platinum, iron, gold, copper, silver, etc. . . . ). Suspensions can also result from drilling mud or tailings derived from the treatment of oil sand. These suspensions generally comprise organic and/or mineral particles such as clays, sediments, sand, metal oxides, oil, etc. . . . , mixed with water.

The treatment of such tailings and other waste material has become a technical, environmental and public policy issue.

It is common practice to use synthetic or natural polymers such as coagulants and flocculants to separate the solids from the liquid.

For a long time, and even nowadays, mineral sludge produced by physical or chemical ore treatment methods were stored above ground in retention lagoons, ponds, dam or embankments in semi-liquid form. These large volumes of stored sludge therefore create a real hazard, notably if the dikes break.

This problem has become clearly important in the case of the phosphate mines, where fairly large dams were accumulated, with each washer releasing two million tons of sludge a year on average. It was common to reach depths of 15 meters of deposits with a sludge concentration around 25% over the long term, with no bearing capacity and therefore presenting a real danger in case of rupture. Such danger unfortunately materializes frequently and the following examples here below list the most recent failures related to phosphate mine operations.

In April 2005, at Bangs Lake, Jackson County (Mississippi, USA), a phosphogypsum stack failure occurred because the company was trying to increase the capacity of the pond at a faster rate than standard according to Officials with the Mississippi Department of Environmental Quality. The company has blamed the spill on unusually heavy rainfall, though. Approximately 17 million gallons of acidic liquid (64,350 m3) were concerned and the liquid poured into adjacent marsh lands caused vegetation to die.

In September 2004, at Riverview (Florida, USA) a dike at the top of a 100-foot-high gypsum stack holding 150-million gallons of polluted water broke after waves driven by Hurricane Frances bashed the dike's southwest corner. 60 million gallons (227,000 m3) of acidic liquid were concerned and liquid spilled into Archie Creek that leads to Hillsborough Bay.

The accidents related to ponds and dam failures occur worldwide and are unpredictable:
Europe (14%) is the second world zone on tailings dam incidents, only surpassed by the USA (43%).
All the European tailings dam failures have occurred in dams of less than 45 m high, of which one third were in dams of 20-30 m in height.
Most of these incidents are related to meteorological causes (26% to unusual rainfall and 3% to snow). Incidents due to seismic liquefaction accounts for 14% of incidents in the world.
Over 85% of the accidents occurred in active tailings dams, and 15% of the incidents were related to abandoned dams.

Dam failures are also associated with mining and mineral industries as shown by the following examples.

In November 2012, at Sotkamo (Kainuu province, Finland), in a nickel mine, a leak from a gypsum pond through a “funnel-shaped hole” caused the spill of hundreds of thousands of cubic metres of contaminated waste water. As a result, the nickel and zinc concentrations in nearby Snow River exceeded the values that are harmful to organisms tenfold or even a hundredfold.

In July 2011, at Mianyang City (Songpan County, Sichuan Province, China), in a Manganese mine, tailings dam was damaged from landslides caused from heavy rains. Tailings damaged residential roads and houses, forcing 272 people to leave and tailings were washed into the Fujiang River, leaving 200,000 people without drinking water supply.

In October 2012, at Kolontár (Hungary), in bauxite mine, a tailings dam failed. 700,000 cubic metres of caustic red mud has been spilled. Several tons of mud flooded, killing 10 people, injuring 120 people, flooding 8 square kilometres.

Since the above described traditional storage solutions are obviously dangerous, more and more national regulations have been issued forbidding abandoning these zones. The regulations also call for an obligation to rehabilitate such sites, i.e. treating and consolidating, or requiring strict authorizations more and more difficult to fulfill.

The improvement of chemical and mechanical treatments of tailings or sludge is therefore a great challenge that needs to be addressed.

Various attempts were made in the past decades to increase the settling rate of the tailings in order to efficiently recycle water and reduce the volume of tailings ponds. The main physical treatments include centrifugation, filtration, electrophoresis and electro-coagulation.

On the other hand, chemical methods are emerging. They include process involving the addition of chemicals such as sodium silicate, organic flocculants, inorganic coagulants, oxidizing and reducing agents and most recently carbon dioxide.

In 1979-1980, Alsthom Atlantique and SNF (U.S. Pat. No. 4,347,140) developed a multistep flocculation system (super-flocculation) specifically designed for treating clay lagoons from phosphate production in Florida.

The treatment of suspensions was continuously studied in 1986 according to the method described in CA 1,273,888, then in 1994 in patent WO 96/05146, in 2000 in patent CA 2,407,869 and in 2004 in patent CA 2,515,581.

In patent CA 2 682 542, the process involves the addition of polymers modified by copolymerization and/or branching. Polymers having hydrophobic groups which have also been studied showed some improvement.

Despite great advances over the last 10 years, there is still a need to develop polymers that may enhance the speed and amount of water released from the tailings. Improvement of the physical characteristics of the produced sludge is also sought.

### SUMMARY OF THE INVENTION

The present invention addresses the above needs by providing a process for improving the treatment of suspensions of solid particles in water thanks to specific water-soluble polymers.

Accordingly, the invention provides a method for treating a suspension of mineral particles in water, including, contacting the said suspension with a water-soluble polymer. The polymer is obtained in two stages, the first stage being a conventional polymerization and the second stage a post-hydrolysis.

According to the invention, it was surprisingly found that the use of these polymers significantly improves the performances of tailings treatment such as tailings concentration in thickener, or the dewatering stage and the drying and solidification stage of the suspensions of mineral particles in water, or the mechanical treatment of treated tailings.

The use of these polymers increases the drainage, water release and general dewatering of the tailings. It also improves the clarity of the released fluid (also called the liquor) that allows the clarified water to be reused and made immediately available for recirculation to the plant. The treated suspension solidifies much faster, resulting in improved dry sludge properties.

### DETAILED DESCRIPTION OF THE INVENTION

The invention relates to a method for treating an aqueous suspension of mineral particles, wherein at least one water soluble polymer is added to the suspension, and wherein said polymer is obtained, prior to its addition, by post-hydrolysis of an initial polymer having at least one hydrolysable monomer unit.

Practically, the invention relates to a method for treating an aqueous suspension of mineral particles comprising:
preparing water soluble polymer by (co)polymerizing at least one monomer having at least one hydrolysable function, post hydrolyzing the (co) polymer,
adding the post hydrolysed polymer to the suspension.

Advantageously, the monomer having at least one hydrolysable function is a non-ionic monomer.

Advantageously, preparation of the (co)polymer includes polymerizing at least one monomer having at least one hydrolysable function, and optionally at least one anionic monomer.

When present, the amount of anionic monomer is preferably less than 10 mol %, as compared to the total molar amount of monomers.

Optionally, preparation of the copolymer includes polymerizing at least one monomer having at least one hydrolysable function, and optionally at least one anionic monomer, and at least one cationic monomer, preferably in an amount of less than 10 mol %.

Optionally, the preparation of the copolymer includes copolymerizing at least one monomer having at least one hydrolysable function, optionally at least one anionic monomer, optionally at least one cationic monomer, and at least one monomer having a hydrophobic character in a range comprised between 0.001 and 1 mol %. This additional monomer may be non-ionic or ionic.

Ionic monomers preferably represent less than 20 mol % of the total amount of monomers.

At least one of the non-ionic monomers of the polymer has a hydrolysable functional group such as for instance an amide or an ester.

Non-ionic monomers having at least one hydrolysable function are preferably selected from the group comprising acrylamide; methacrylamide; N-mono derivatives of acrylamide; N-mono derivatives of methacrylamide; N,N derivatives of acrylamide; N,N derivatives of methacrylamide; acrylic esters; and methacrylic esters.

The most preferred non-ionic monomer is acrylamide.

Anionic monomers are preferably selected from the group comprising monomers having a carboxylic function and salts thereof; monomers having a sulfonic acid function and salts thereof; monomers having a phosphonic acid function and salts thereof. They include for instance acrylic acid, acrylamide tertio butyl sulfonic acid, methacrylic acid, maleic acid, itaconic acid; and hemi esters thereof.

The most preferred anionic monomers are acrylic acid, acrylamide tertio butyl sulfonic acid (ATBS), and salts thereof. Generally, salts are alkaline salts, alkaline earth salts or ammonium salts.

Cationic monomers are preferably selected from the group comprising dimethylaminoethyl acrylate (DMAEA) quaternized or salified; dimethylaminoethyl methacrylate (DMAEMA) quaternized or salified; diallyldimethyl ammonium chloride (DADMAC); acrylamidopropyltrimethylammonium chloride (APTAC); methacrylamidopropyltrimethylammonium chloride (MAPTAC).

Other monomers could be used for the preparation of the (co)polymer for example N-Vinyl Pyrrolidone (NVP), or AcryloyMorholine (ACMO).

The monomer having a hydrophobic character can be of the general formula:

R1—R2—R3, in which:
R1 designates a polymerizable unsaturated group, belonging to the group of vinylics, such as, but not limited to, (meth)vinyl, (meth)allyl, (meth)acrylamide, (meth)acrylate, (hemiester, hemiamide, amide ester, diesters, diamide) of itaconic, maleic, fumaric, crotonic or methylidene malonic acid. When at least one N is present, at least one is monofunctionalized or di- or trifunctionalized with similar or different R2. The rest of the functions are R4,
R2 designates a single bond or at least one alkylene oxide repeating unit, having 1 to 5 carbon atoms. When R2 has at least two different alkylene oxide groups, they can be repeated randomly, alternately or in block.
R3 designates a linear or branched or cyclic alkyl or aryl alkyl chain comprising at least 4 carbon atoms, and optionally comprising at least one S, P, O or N atoms and can be cationic, anionic, zwitterionic or non-ionic,
R4 designates H, a linear or branched or cyclic alkyl or aryl alkyl chain comprising at least 1 carbon atoms, and optionally comprising at least one S, P, O or N atoms.

Monomer having a hydrophobic character can be preferably selected from the group comprising (meth)acrylic acid esters having an alkyl, arylalkyl or ethoxylated chain; derivatives of (meth)acrylamide having an alkyl, arylalkyl or dialkyl chain; cationic allyl derivatives; anionic or cationic hydrophobic (meth)acryloyl derivatives; and anionic or cationic monomers derivatives of (meth)acrylamide bearing a hydrophobic chain.

In a known manner, the polymer is linear or structured. As is known, a structured polymer is a polymer that can have the form of a star, a comb, or has pending groups of pending chains on the side of the main chain.

For instance, branching can preferably be carried out during the polymerization of the monomers, in the presence of a branching/crosslinking agent and possibly a transfer agent. A non-exhaustive list of branching agents includes: methylenebisacrylamide (MBA), ethylene glycol diacrylate, polyethylene glycol dimethacrylate, vinyloxyethyl acrylate, vinyloxyethyl methacrylate, triallylamine, glyoxal, compounds of the glycidyl ether type such as ethylene glycol diglycidyl ether, or epoxies or any other method known to the person skilled in the art, producing branching.

The amount of branching/crosslinking agent in the monomer mixture is less than 1% in weight relative to the monomer content.

The polymerization can be carried out according to any polymerization techniques well known to a person skilled in the art:solution polymerization, suspension polymerization, gel polymerization, precipitation polymerization, emulsion polymerization (aqueous or reverse) followed or not by spray drying step, suspension polymerization, micellar polymerization followed or not by a precipitation step.

In a preferred embodiment, polymerization is a gel polymerization.

The polymerization is generally a free radical polymerization preferably by inverse emulsion polymerization or gel polymerization. By free radical polymerization, we include free radical polymerization by means of U.V. azoic, redox or thermal initiators and also Controlled Radical Polymerization (CRP) techniques or template polymerization techniques.

As already specified, the polymer used in the method according to the invention is obtained in two stages. The second stage is a post-hydrolysis stage comprising the step of reacting the polymer obtained after the polymerization stage. This reaction consists in reacting the hydrolysable functional group of the non-ionic monomer with a base. In other words, a polymer comprising hydrolysable monomers such as monomers having an amide or ester group is prepared. It is then hydrolyzed.

During the post-hydrolysis stage of the polymer, the amount of carboxylic acid functionalities increases. Indeed, the reaction between a base and the amide or the ester side groups of the initially formed polymer results in the formation of a carboxylate group. The hydrolysis reaction of an amide or ester to a carboxylate involves the release of amine, ammonia or alcohol.

In a preferred embodiment, the polymer contains at least 50 mol % of monomers having at least one hydrolysable function, preferably at least 60 mol %, more preferably at least 80 mol %.

The rate of post-hydrolysis is the ratio between the number of functions which are hydrolyzed during the post hydrolyzed stage of the polymer and the total number of hydrolysable functions in the polymer.

In a preferred embodiment, the rate of post hydrolyzis is at least 10%, preferably at least 20%. The maximum rate of post hydrolyzis depends of parameters such as the content of monomers having hydrolysable function, the number of hydrolysable functions on each monomers, the carboxylate functions content in the polymer. This maximum rate is obtained when the anionicity of the polymer after the post hydrolyzation is 55 mol %.

The reaction between the polymer and a base is preferably carried out at a temperature of from 40 to 120° C., preferably from 55 to 95° C. In general, the hydrolysis reaction is carried out, within this temperature range, for 5 to 600 minutes, preferably for 15 to 200 minutes.

The skilled man of the art will be able to easily determine the experimental conditions (temperature, duration, amount of base) suitable in order to obtain the desired polymer.

Generally, the base is gently added, under moderate mechanical stirring, into the tank containing the initial polymer which is obtained after the first stage.

Any regular base may be used, but for cost and efficiency reasons, the base is preferably selected from the group comprising oxide, hydroxide, carbonate and borate of alkali metals such as the elements of either the Group 1 of the periodic table (for instance sodium, and potassium, cesium) or the Group 2 (for instance, calcium and magnesium). According a particular embodiment, the base may be lime (calcium hydroxide) or caustic (sodium hydroxide). It is preferably a strong base.

The amount of base used to perform the post hydrolysis stage is preferably greater than 10 mol % of the total amount of hydrolysable non-ionic monomer of the initial polymer.

After the post-hydrolysis stage, the resulting water-soluble polymer has an anionicity preferably ranging from between 10 to 55 mol %, preferably from 20 to 50 mol %. The anionicity results from the hydrolyzed groups and from the optional ionic monomers incorporated at the stage 1, i.e. the preparation of the polymer. The molecular weight of the said post-hydrolyzed polymer is preferably comprised between 15 and 40 millions daltons, and more preferably between 18 and 30 millions.

After the post hydrolysis stage, the polymer can be further processed to remove water, process solvent or other volatile compounds. The polymer may as well be post-acidified, and/or dried by any appropriate method. These subsequent steps are known to a person skilled in the art to improve the physical properties or the resulting polymer in terms of concentration, stability, handling properties, and speed of solubilization.

The water-soluble polymer resulting from the post-hydrolysis stage can consist of a liquid, preferably an inverse emulsion form, or a solid, preferably a powder, or a spray dried powder.

When the polymer comprises monomers having amide or esters groups, the hydrolysis reaction allows the formation of salts of carboxylic acid. Indeed, the amide of acrylamide is converted to an acrylate functional group.

As a consequence, when the polymer is, for instance, a copolymer of 95 mol % of acrylamide and 5 mol % of a salt of acrylic acid, the hydrolysis of 10% of the acrylamide monomers affords a copolymer having 85.5 mol % (95-9.5) of acrylamide and 14.5 mol % (5+9.5) of salts of acrylic acid. In this case, the rate of post hydrolysis is 10%.

However, such a post-hydrolyzed copolymer is different from a polymer that has been prepared by polymerization of 85.5 mol % of acrylamide and 14.5 mol % of salts of acrylic acid. The main polymeric chains of these two polymers obtained from two distinct processes, are not the same. The monomer sequences are not the same. As a consequence, these monomers can exhibit properties that are specific to their preparation i.e. copolymerization vs. post hydrolysis.

As already mentioned, the invention relates to a method for treating suspensions of solid particles in water. It involves mixing the suspension with a post-hydrolyzed water-soluble polymer.

Such treatment can be carried out into a thickener, which is a holding area wherein the particles may settle at the bottom. According to a specific embodiment, the polymer is added into the pipe transporting the suspension to a thickener.

According to another specific embodiment, the polymer is added into a thickener containing the suspension to treat. In a typical mineral processing operation, tailings are often concentrated by flocculation process in a thickener to give higher density underflow, and to recover some of the process water. The addition of the polymer enhances the concentration of the underflow and increases the quality of the liquor.

According to another specific embodiment, the water-soluble polymer is added to the suspension of solid particles in water, during the transport of the said suspension to a deposition area. Preferably, the polymer is added into the pipe transporting the said suspension to a deposition area on which the treated suspension is spread of for dewatering and solidifying. Examples of such treatment are beach drying, or deep cell (accelerated dewatering).

According to another specific embodiment, the water-soluble polymer is added to the suspension and then followed by a mechanical treatment such as centrifugation, screw press and filtration.

The polymer may be added simultaneously at different stage of the suspension treatment, i.e. for example into the pipe transporting the suspension to a thickener and in the underflow of the thickener.

The polymer can be added in liquid form or in solid form. The polymer can be added as an emulsion (water in oil), a solution, a powder, or a dispersion of polymer in oil. The polymer is preferably added in an aqueous solution.

If the polymer is in a solid form, it could be partially or totally dissolved in water with the Polymer Slicing Unit (PSU) disclosed in WO 2008/107492.

According to another specific embodiment, the polymer is added to the suspension in combination with another polymer, synthetic or natural. These at least two polymers can be added simultaneously or separately. The other polymer can be water-soluble or water swellable. It can be a dispersant, a coagulant or a flocculant. The combination of the above described water soluble hydrolyzed polymer and an anionic polymer having a molecular weight of less than 5 millions daltons, and an anionicity of between 40 and 100 mol %, is preferred. Such additional anionic polymer is described in the patent CA 2 364 854.

According to the invention, the total dosage of polymer added is between 50 and 5,000 g per ton of dry solids of suspension, preferably between 250 and 2,000 g/t, and more preferably between 500 and 1,500 g/t, depending on the nature and the composition of the tailings to be treated.

According to the invention, the method using a post-hydrolyzed polymer permits to treat more efficiently mineral material.

Suspensions of mineral particles in water include all types of sludge, tailings, or waste materials. The suspensions result from mineral ores processes and consist of, for instance, industrial sludge or tailings and all mine wash and waste products from exploiting mines, such as, for example, coal mines, diamonds mines, phosphate mines, metal mines (alumina, platinum, iron, gold, copper, silver, etc. . . . ). Suspensions are also drilling mud or tailings derived from the treatment of oil sand. These suspensions generally comprise organic and/or mineral particles such as clays, sediments, sand, metal oxides, oil, etc. . . . , mixed with water.

Generally, suspensions are concentrated, and contains between 10% and 60% solids, preferably between 20 and 50% solids.

The method according to the invention is especially useful for the treatment of tailings resulting from oil sand extraction, such as Mature Fine Tailings (MFT).

The treatment of oil sand tailings has recently become an increasing issue in Canada. The tailings waste goes to tailings pond or thickeners for further water management. The oil sands tailings are alkaline aqueous suspensions which contain un-recovered residual bitumen, salts, soluble organic compounds, sands and clays. The tailings are discharged to tailings ponds for storage.

The tailings ponds are also closely regulated by the government. Two to four barrels of fresh water are required per barrel of oil produced from the surface mining method. After the tailings slurry is discharged to the tailings ponds, the coarse solids segregate as the dykes while most of the water and fine solids remain as suspensions in the tailings pond. A layer of mature fine tails (MFT) develops after two to three years. MFT consolidates very slowly. The completion of the settling process is predicted to take almost a century.

The use of post-hydrolyzed polymer for treating MFT increases the performances in terms of net water release and yield strength of treated MFT.

Obviously, the following examples are only given to illustrate the subject matter of the invention, which is in no way restricted to them.

### Example 1

### Polymer Preparation

Polymer 1 (Invention)

An anionic polyacrylamide is first synthetized by template polymerization. It is then post-hydrolyzed.

91 mol % of acrylamide, 6 mol % of acrylic acid (AA monomer) and 3 mol % of acrylamide tertio butyl sulfonic acid (ATBS) and 1 weight %, with regards to active monomers, of a cationic template are added with deionized water in a beaker to prepare an aqueous solution of monomers. The total amount of monomers is 24 w % and the total weight of the solution is 1.5 kg, without taking into account the amount of cationic template in this calculation. The cationic template is a cationic oligomer having a molecular weight of 5.000 g/mol. The pH of the monomer solution is adjusted to 7 by adding NaOH. It is cooled down to a temperature of 5° C. Due to the presence of NaOH, acrylic acid is converted to sodium acrylate while ATBS is converted to sodium ATBS.

The following additives are then added to the solution:
30 ppm of Versenex 80 (complexing agent),
150 ppm of Azo-bis-Isobutyronitrile (AZDN) (azoic initiator),
0.5 ppm of Terbuthylhydroperoxide (TBHP) (oxididant).

The mixture is then transferred into a heat-insulated reaction vessel and inert gas is passed through the mixture for 15 minutes to remove oxygen. 1.5 ppm of Mohr's salt are then added in order to start the polymerization. The polymerization reaction starts and continues under adiabatic conditions until the temperature reaches 85° C.

Once the polymerization is over, the second stage (post hydrolysis) is started by grinding the gel in pieces of less than 1 cm diameter and by subsequently adding sodium hydroxide in solution (50 w %) during 90 minutes at a temperature of 90° C. in order to obtain a final anionicity of the post and hydrolyzed polymer of 35 mol %. The experimental conditions are different from the initial addition of NaOH, which was allowed the neutralization of the acrylic and sulfonic acids (AA and ATBS monomers). The initial addition of NaOH does not result in the hydrolysis of acrylamide.

The rate of post hydrolysis is 32% ((35-6)/91).

The resulting gel is then further grinded and dried in an oven to afford a powder.

Polymer 2 (Counter Example)

An anionic polyacrylamide is synthetized by template polymerization and then post-hydrolyzed.

65 mol % of acrylamide, 32 mol % of acrylic acid and 3 mol % of acrylamide tertio butyl sulfonic acid (ATBS) and 1 weight % with regards to active monomers, of a cationic template are added with deionized water in a beaker to prepare the aqueous solution. The total amount of monomers is 24 w % and the total weight of the solution is 1.5 kg without taking account of the cationic template in this calculation. The cationic template is a cationic oligomer having a molecular weight of 5.000 g/mol. The pH is adjusted to 7 with NaOH, and the temperature to 5° C. Acrylic acid is converted to sodium acrylate while ATBS is converted to sodium ATBS.

The following additives are then added to the solution:
30 ppm of Versenex 80 (complexing agent),
150 ppm of Azo-bis-Isobutyronitrile (AZDN) (azoic initiator),
0.5 ppm of Terbuthylhydroperoxide (TBHP) (oxididant).

The mixture is then transferred into a heat-insulated reaction vessel and inert gas is passed through the mixture for 15 minutes to remove oxygen. 1.5 ppm of Mohr's salt are then added in order to start the polymerization. The polymerization reaction starts and continues under adiabatic conditions until the temperature reaches 85° C. There is no second stage and the gel is then grinded and dried in an oven to obtain a powder. The anionicity of the resulting polymer is 35 mol %.

### Example 2

### Method—Flocculation

A Mature Fine Tailings (MFT) having 50% solids is flocculated with a polymer solution (0.4% in weight). 500 or 600 g/t (grams per tons of dry solids of suspension) of different polymers are added into 200 g of MFT and then mixed manually.

The following results are obtained and disclosed in Table 1.

TABLE 1
Flocculation in the presence of a polymeric additive

| | Dosage | Net Water | |
|---|---|---|---|
| Polymer | (g/t) | Release (%) | Note on flocculation |
| 2 (counter example) | 500 | 34.3 | flocs |
| | | | dirty water |
| 2 (counter example) | 600 | 37.1 | strong flocs |
| | | | clean water |
| 1 (invention) | 500 | 42.2 | very strong flocs |
| | | | very clean water |
| 1 (invention) | 600 | 42.6 | very strong flocs |
| | | | very clean water |

Net Water Release corresponds to the total amount of water recovered during the flocculation test.

The polymer having a post-hydrolysis stage gives better results than the same polymer (same anionicity, 35 mol %) with a lower dosage.

### Example 3

### Flocculation and Mechanical Treatment

Mature fine tailings (MFT) from a waste storage lagoon are transported by dredging with an average concentration of 450 g/l. The sludge is transported approximately 2 km and treated with polymer 1 and 2 in aqueous solutionat a concentration of 5 g/L.

Solutions are fed into the MFT feed pipe at three points in quantities ranging from 1000 g per ton of solids. The treated MFT is then introduced into mechanical dewatering centrifuges commonly referred to as decanters. The flocculated sludge is exposed to the high energy mixing zone of the decanter. Quick floc formations are generated, followed by a slight shearing of the formations. The overall action of mixing and shearing results in additionally reclaimed water release from the process. The resulting dewatered cake and centrate or reclaimed water are disclosed in Table 2

TABLE 2
Characteristics of the dewatered cakes

| | Cake solids | Total Supsended |
|---|---|---|
| | content (% w) | Solid (%) |
| Polymer 1 | 62% | 0.8 |
| Polymer 2 | 47% | 2.1 |

1. A method for treating an aqueous suspension of mineral particles comprising the steps of:
preparing a water-soluble polymer by (co)polymerizing at least one monomer having at least one hydrolysable function,
post hydrolyzing the (co) polymer,
adding the post hydrolysed polymer to the suspension.

2. The method of claim 1, wherein the monomer having at least one hydrolysable function is a non-ionic monomer.

3. The method of claim 2, wherein the non-ionic monomer having at least one hydrolysable function is selected from the group consisting of acrylamide; methacrylamide; N-mono derivatives of acrylamide; N-mono derivatives of methacrylamide; N,N derivatives of acrylamide; N,N derivatives of methacrylamide; acrylic esters; and methacrylic esters.

4. The method of claim 1, wherein the water soluble polymer contains at least 50 mol % of monomers having at least one hydrolysable function.

5. The method of claim 1, wherein a ratio between a number of functions which are hydrolyzed during the post hydrolyzation and a total number of hydrolysable functions in the polymer is at least 10%.

6. The method of claim 1 wherein said step of preparing the polymer comprises (co)polymerizing at least one monomer having at least one hydrolysable function and at least one anionic monomer.

7. The method of claim 6 wherein the at least one anionic monomer is in an amount of less than 10 mol %.

8. The method of claim 6, wherein the anionic monomer is selected from the group consisting of monomers having a carboxylic function and salts thereof; monomers having a sulfonic acid function and salts thereof; and monomers having a phosphonic acid function and salts thereof.

9. The method of claim 6, wherein the anionic monomer is selected from the group consisting of acrylic acid; acrylamide tertio butyl sulfonic acid; methacrylic acid; maleic acid; and itaconic acid.

10. The method of claim 1, wherein said step of preparing the copolymer comprises copolymerizing at least one monomer having at least one hydrolysable function, and at least one monomer having a hydrophobic character in a range comprised between 0.001 and 1 mol %.

11. The method of claim 1, wherein said post-hydrolysing step comprises reacting the polymer with a base.

12. The method of claim 1, wherein post-hydrolysation is carried out at a temperature of between 40 and 120° C., for 5 minutes to 600 minutes.

13. The method of claim 11, wherein the base is a strong base selected from the group consisting of oxide, hydroxide, carbonate and borate of the elements that make up Groups 1 or 2 of the periodic table.

14. The method of claim 1, wherein the post-hydrolysed polymer has an anionicity of between 10 to 55 mol %.

15. The method of claim 1, wherein the post-hydrolyzed water-soluble polymer has a molecular weight comprised between 15 and 40 millions daltons.

16. The method of claim 1, wherein the water-soluble polymer is added into a pipe transporting the suspension to a thickener.

17. The method of claim 1, wherein the water-soluble polymer is added into a thickener containing the suspension to treat.

18. The method of claim 1, wherein the water-soluble polymer is added to the suspension of mineral particles in water, during transport of the suspension to a deposition area.

19. The method of claim 18, wherein, the polymer is added into a pipe transporting the suspension to a deposition area.

20. The method of claim 1, wherein the suspension of mineral particles in water include all types of sludge, tailings, or waste materials, results of mineral ores processes, drilling mud or tailings derived from the treatment of oil sand.
